(19) United States
(12) Patent Application Publication
(10) Pub. No.: US 2023/0065344 A1
(43) Pub. Date: Mar. 2, 2023

(54) STOP WITH HOOK ATTACHABLE TO CHAINSAW BAR

(71) Applicant: Arthur H. Krugler, Grass Valley, CA (US)

(72) Inventor: Arthur H. Krugler, Grass Valley, CA (US)

(21) Appl. No.: 17/959,056

(22) Filed: Oct. 3, 2022

Related U.S. Application Data
(63) Continuation-in-part of application No. 17/462,492, filed on Aug. 31, 2021, now Pat. No. 11,485,039.

(51) Int. Cl. B27B 17/00; B27B 17/02

(52) U.S. Cl. CPC B27B 17/0083; B27B 17/02

(57) ABSTRACT

A stop has an elongate form between a base and a tip, with the base configured to be attachable to a chainsaw bar closer to a free end of the bar than to a housing of the chainsaw. The stop extends below a lower edge of the bar. Fasteners pass through holes in the stop and through holes in the bar for attachment. Positioning of the stop separates a tip space from a main space where chain teeth can cut wooden material. Smaller branches can conveniently be cut in the tip space while larger wooden material can be cut in the main space. The stop is configured to include clearance for the chain to pass thereby, such as by including standoffs adjacent to holes at the base, or by providing a clearance groove or bend. The stop can include a hook to facilitate engagement with and moving of small objects.

### CROSS-REFERENCE TO RELATED APPLICATIONS

This application is a continuation-in-part of U.S. patent application Ser. No. 17/462,492, filed on Aug. 31, 2021, incorporated herein by reference in its entirety.

### FIELD OF THE INVENTION

The following invention relates to chainsaws for providing a handheld tool to cut wooden material. More particularly, this invention relates to stops and other accessories for chainsaws which attach to a bar of a chainsaw to enhance chainsaw utility in cutting and manipulating both small and large material.

### BACKGROUND OF THE INVENTION

Origin of the chainsaw is uncertain. A saw of the chain type was invented and used by two surgeons in Scotland, in 1780 to saw through bones during surgery. There is a report that a German surgeon, Bernhard Heine, “invented” a chainsaw in 1830 for similar use.

It was adapted to cutting trees and in the 1900's a two man chainsaw could be purchased at Montgomery Ward & Company. It had a heavy 4 stroke gasoline engine, a 3 foot blade. Operation required two strong men, one using two handles to carry the motor and a second man using a handle beyond the blade. The engine remained vertical while the blade could be tilted to cut horizontally during felling a tree and then tilted vertically to cut logs to length.

Development of two cycle engines that could operate in any position resulted in the modern chainsaw after 1950. The nuisance of having to add lubricating oil to the gasoline for the two stroke engine was far outweighed by the lighter and more versatile engine. Chains must be constantly lubricated to avoid early wear and self lubricators were also developed using oil from a small reservoir.

Of major importance is the role chainsaws play in preventing and controlling forest fires. Before fire season fire-free zones are created along evacuation roads, around homes and other structures. Chainsaws are vital to cutting down nearby trees and brush to clear the area of dry combustible fuels. “Firebreaks” are also created to remove fuel from a lane through forest areas. Again, chainsaws are the most important tool. Bulldozers are used but are slow, clumsy and subject to roll-over on slopes. Control of forest fires is largely accomplished by using chainsaws to create a fuel-free lane close to the fire and setting backfires to burn away combustible brush and trees between the lane and the fire. Having a chainsaw that cuts brush and tree limbs much faster would be a valuable asset.

It is known in the prior art to provide attachments and/or modifications to chainsaws to make them useful in trimming bushes and hedges. With such devices, a series of stationary stops are mounted to the blade/bar of the chainsaw with tips of the multiple stops extending below the chain on the lower edge of the blade/bar. The stops limit the size of material that can be cut down to about four inches or less. While useful for smaller diameter material, such attachments prevent use of the chainsaw on larger material.

### SUMMARY OF THE INVENTION

With this invention, a chainsaw is provided which has been modified by a stop. The chainsaw can be any of a variety of chainsaws which do not need modification according to this invention, other than forming of holes near a tip of the bar for attachment of the stop to the bar.

The stop is an elongate structure formed of rigid material such as steel or high strength plastic. The elongate structure extends from the base to a tip. The base includes holes through which fasteners can pass, and which also can pass through holes in the bar for mounting of the stop to the bar. The structure of the stop can have different cross-sections in different forms, with one embodiment configuring the structure with a planar web bounded at forward and rearward edges with parallel flanges.

While the stop could have a variety of different lengths, one appropriate length is to cause the tip of the stop to extend down from the lower edge of the bar a distance similar to about half of a distance from a mounting location on the bar to a free end of the bar. For instance, if the stop is mounted to the bar six inches from the free end of the bar, the tip can extend about three inches from the lower edge of the bar. With such a sizing, branches or other wooden material having a diameter or other size of up to about six inches can be cut by placement of such items adjacent to the lower edge of the chainsaw blade and forward of the stop. Similarly, a stop extending five inches below the chain could cut wooden material up to ten inches in diameter.

Importantly, larger material can still be cut by the chainsaw by utilizing a main space between the stop and the housing of the chainsaw which is left open and usable by the placement of the stop closer to the free end of the bar than to the housing. Also, in one embodiment the stop has a linear form but is angled forward somewhat so that an angle between the centerline of the bar and a longest dimension of the stop is less than 90°. This angling of the stop causes the stop to “feed” wood to be cut up against the chain. The stop thus facilitates “automatic cutting” in a rapid and efficient manner. The operator does not need to continually press the chain against the wood. Once the chain contacts the wood (e.g. a branch) the wood is pulled against the stop by the chain. The angle of the stop provides a slanted “ramp” that automatically pulls the wood against the chain and completes the cut, rapidly and automatically allowing the successive cutting of multiple branches in under one second.

The tip of the stop not only acts as a reference surface to allow cutting of smaller material adjacent to the free end of the bar, but also helps to keep the free end of the bar from coming into contact with the ground while cutting trunks or branches close to the ground and dulling the teeth on the chain. The tip of the stop can also act as a rest when the saw is not in use, to keep the chain off of the ground when not in use, and off of the ground when starting the saw. The stop near the end of the tip prevents branches from pulling the chain off of the bar. In particular, small flexible branches cut six inches or more from a trunk can be pulled along the chain and can then “grip” the chain within the narrow kerf. The branch can then pull the chain out of its bar track and bend the chain. The stop resists such branch movement and then the chain cuts the branch, preventing chain damage and/or displacement off of the bar.

A clearance space is provided for the teeth of the chain to safely pass the stop when the chainsaw is in operation. In one embodiment, such clearance space is provided by including standoffs formed into the planar web surrounding the holes at the base of the stop. A height of these standoffs causes the planar web to be spaced away from a mounting plane (aligned with a surface of the bar), which also acts to provide clearance for teeth of the chain to pass the stop. As an alternative or in addition to the standoffs, washers can be provided between the stop and the bar surface, surrounding bolts or other fasteners passing through holes in the stop and bar for mounting of the stop to the bar. Other options including a clearance groove formed in the stop to provide appropriate clearance for chain teeth, or including a bend in the stop so that a clearance space is provided at a location where the chain teeth pass the stop.

The stop can include a hook at a distal end of the stop as shown in the drawings. The hook allows the tip of the stop to more effectively move branches, small pieces of wood or other objects, while a user of the chainsaw keeps hands safely upon handles/grips of the saw. In particular, the hook allows an operator to “hook” a branch and pull it either into position for cutting or out of the way to facilitate cutting other wood. The hook can also move objects such as rocks/leaves/dirt to keep them from dulling and/or damaging the chain, especially when cutting a tree trunk near the ground. The stop can, in one embodiment, be formed from a single piece of appropriately bent and contoured metal.

### OBJECTS OF THE INVENTION

Accordingly, a primary object of the present invention is to provide a dual (or even triple) service saw and/or a method for modifying a chainsaw to become a dual (or triple) service saw, combining the utility of a long bar saw and a short bar saw together in a single chainsaw and with a hook to facilitate movement of branches and other objects.

Another object of the present invention is to provide a chainsaw equipped with an additional stop to allow the chainsaw to be used as a normal saw in felling trees or cutting logs which fit within a main space of the saw behind the stop, while also facilitating cutting of smaller branches forward of the stop near a free end of the bar.

Another object of the present invention is to provide a stop attachable to a chainsaw to reduce risk that a chain will be damaged or thrown off of the bar by cutting small branches.

Another object of the present invention is to reduce risk of striking rocks with a tip of a chain by allowing small branches to be more easily cut at locations further from the ground without flexing of the branches inhibiting the cutting of the branches.

Another object of the present invention is to provide a chainsaw which can more rapidly cut a wide variety of sizes of wooden material by locating a stop on the saw to provide two portions of the saw optimized for cutting of different size material.

Another object of the present invention is to provide a chainsaw optimized for fire fighting in that the chainsaw can rapidly cut paths through brush for establishing a firebreak, with the single saw both cutting small branches and larger wooden material with different portions of the same chainsaw.

Another object of the present invention is to provide a stop attachable to a chainsaw (and associated method) which can be attached to a chainsaw with a minimum of modification to the chainsaw and which can allow the chainsaw to more readily cut small branches and other small wooden material.

Another object of the present invention is to provide a stop attachable to a chainsaw which includes a hook so that the stop of the saw can be used as a rake or hoe to manipulate various objects, while a user's hands remain on a grip and/or handle of the saw.

Other further objects of the present invention will become apparent from a careful reading of the included drawing figures, the claims and detailed description of the invention.

### BRIEF DESCRIPTION OF THE DRAWINGS

FIG. 1 is a side elevation view of a chainsaw with a stop according to one embodiment of this invention attached to a bar thereof, and showing a large wooden member and a smaller wooden member adjacent to the chainsaw to illustrate function of the chainsaw with the stop in place.

FIG. 2 is a perspective view of that which is shown in FIG. 1, illustrating how the stop is attached to the bar of the chainsaw.

FIG. 3 is a left side elevation view of the stop of FIG. 1.

FIG. 4 is a right side elevation view of that which is shown in FIG. 3.

FIG. 5 is a front elevation view of that which is shown in FIG. 3, and with broken lines illustrating an alternative embodiment clearance groove.

FIG. 6 is a rear elevation view of that which is shown in FIG. 3, and with broken lines illustrating an alternative embodiment bent stop.

FIG. 7 is a top plan view of that which is shown in FIG. 4.

FIG. 8 is a bottom plan view of that which is shown in FIG. 4.

FIG. 9 is a top plan section view taken along line 9-9 of FIG. 4.

FIG. 10 is a top plan sectional view taken along line 10-10 of FIG. 4.

FIG. 11 is a front elevation view of an alternative stop featuring a hook thereon, with the stop attached to a typical chainsaw bar.

FIG. 12 is a perspective view of the alternative stop of FIG. 11.

FIG. 13 is a front elevation view of that which is shown in FIG. 12.

FIG. 14 is a rear elevation view of that which is shown in FIG. 12.

FIG. 15 is a left side elevation view of that which is shown in FIG. 12.

FIG. 16 is a right side elevation view of that which is shown in FIG. 12.

FIG. 17 is a top plan view of that which is shown in FIG. 12.

FIG. 18 is a bottom plan view of that which is shown in FIG. 12.

### DESCRIPTION OF THE PREFERRED EMBODIMENT

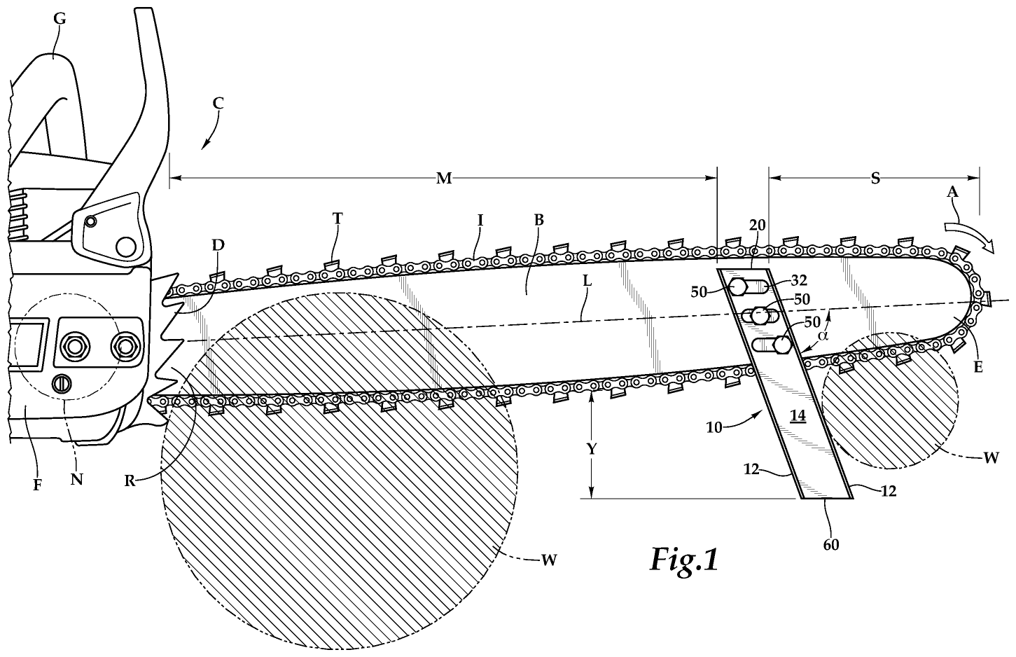

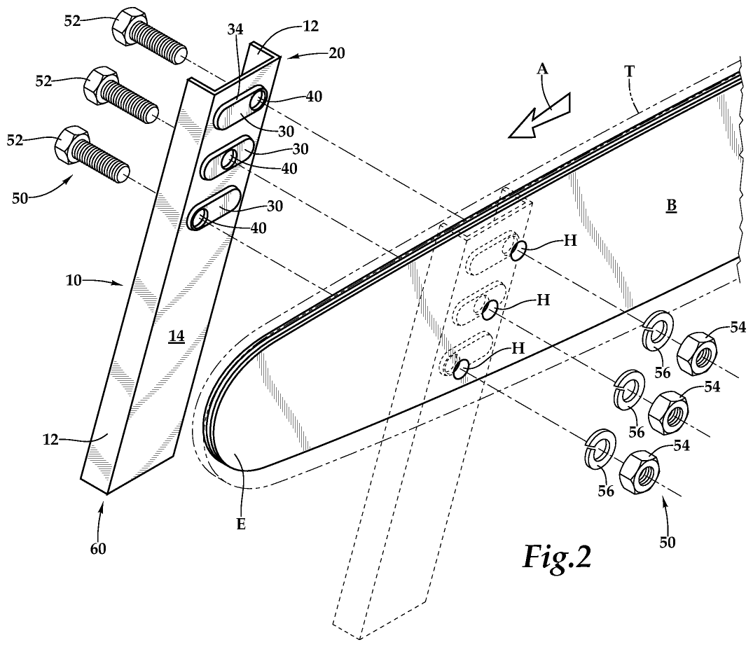

Referring to the drawings, wherein like reference numerals represent like parts throughout the various drawing figures, reference numeral 10 is directed to a stop for a chainsaw C (FIG. 1). This stop 10 is configured to attach to a blade/bar B (FIG. 2) of a chainsaw C so that the chainsaw C can be configured to more effectively cut branches and other small material W, while maintaining the chainsaw's ability to also cut larger diameter material W.

In essence, and with particular reference to FIGS. 1 and 2, basic details of the stop 10 are described, according to one example embodiment. The stop 10 is an elongated rigid structure extending from a base end 20 to a tip 60. Standoffs 30 preferably surround holes 40 in the base end 20 of the stop 10. Fasteners 50 interact with the holes 40 (and holes H) to mount the base end 20 of the stop 10 to the blade/bar B of the chainsaw C. Strategic positioning of the stop 10 relative to the bar B causes a tip space S between the stop 10 and a free end E of the bar B to be smaller than a main space M between the stop 10 and a root R of the bar B opposite of the free end E, and adjacent to a housing of the chainsaw C. The standoffs 30 provide a clearance space for passage of teeth T of the chain I carried by the bar B to avoid striking the stop 10 as the chain I moves along arrow A. Alternatively or in addition, a clearance groove 120 (FIG. 5) can be provided to keep the stop 10 from contacting the teeth T of the chain I, or the stop 10 can be configured with a bend 110 (FIG. 6) to keep the stop 10 from contacting the teeth T of the chain I.

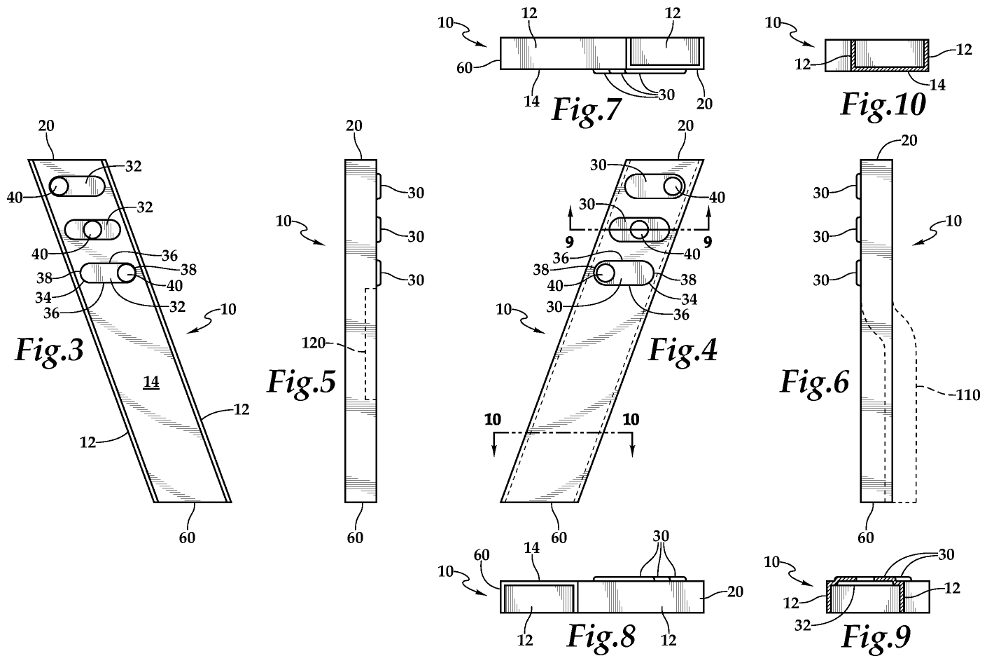

More specifically, and with particular reference to FIGS. 3-10, details of the stop 10 are described according to one example embodiment. This stop 10 is a rigid elongate structure having a greater length than its width or thickness. The stop 10 is formed of rigid material, such as steel or other metal or high strength polymeric hydrocarbon material or similar material. Most preferably, the stop 10 is formed by extrusion and/or bending/pressing of a planar sheet of steel into the finished form desired for the stop 10.

A general form of the stop 10 includes a planar web 14 bounded on forward and rearward edges by two parallel flanges 12. The flanges 12 are preferably oriented perpendicular to the web 14 so that the stop 10 has the general cross-sectional form of C-channel. The flanges 12 extend in a direction away from a mounting plane, which mounting plane defines a surface of the bar B to which the stop 10 attaches. In this way, the flanges 12 add rigidity and strength to the stop 10, without the flanges 12 risking coming into contact with the teeth T of the chain I as the chain I moves (along arrow A of FIG. 1) upon the edges of the bar B. In other embodiments, the flanges 12 could be eliminated or have other configurations.

The base end 20 of the stop 10 define a portion of the stop 10 which attaches to the bar B of the chainsaw C. In this example embodiment, three holes 40 pass through the stop 10 near the base end 20. Other numbers of holes could alternatively be provided. Holes H are also formed in the bar B (FIG. 2) which can be aligned with the holes 40 in the stop 10. Fasteners 50, such as bolts 52, nuts 54 and washers 56 (FIG. 2) can work with the holes 40 and holes H to secure the stop 10 to the bar B.

While three holes 40 are shown in this example embodiment, two holes 40 could alternatively be utilized. It is also conceivable that a single hole could be provided, so long as some structure is provided to prevent rotation of the stop 10 relative to the bar B. Larger number of holes H could also alternatively be provided. The holes 40 are shown with a particular pattern relative to each other. Such an arrangement of holes 40 allows for sufficient space so the holes 40 do not weaken the stop 10 or the corresponding holes H in the bar B do not appreciably weaken the bar B, even if the stop 10 is not attached. The stop 10 could be modified to have different shapes and orientations to allow for various different numbers of holes to be positioned at different locations in the bar B and within such a modified stop.

The holes 40 preferably are located within standoffs 30. These standoffs 30 are in this embodiment formed by pressing elongate wells 32 into a surface of the web 14 between the flanges 12, to cause the standoffs 30 to protrude from a surface of the web 14 adjacent to the mounting plane. The wells 32 preferably are oblong in form with a stepped perimeter 34 defining a depth of the wells 32 and a height of the standoffs 30. The wells 32 have parallel sides 36 opposite each other which sides 36 are generally horizontal, and which space apart ends 38 at a forward and rearward extent of each of the wells 32.

The holes 40 reside within these wells 32 and preferably a space between the sides 36 of the wells 32 is similar to a diameter of the holes 40. In this particular embodiment, the wells 32 are centrally aligned with an elongate central axis of the stop 10, but with the holes 40 having differing positions within each of the wells 32, with a lowermost hole 40 being located most forward, and with an uppermost well 32 having its corresponding hole 40 located most rearward, and with a hole 40 in a central well 32 located at a center point thereof.

As an alternative, or in addition, washers 56 (FIG. 2) could be provided adjacent to the holes 40. Such washers 56 could be lock washers or plain washers, or a combination of both. Washers 56 can help to keep bolt 52 and nut 54 pairs from becoming loosened when encountering vibration. Furthermore, the washers 56 help to increase the spacing from the web 14 to the mounting plane, which clearance space helps to keep the chain teeth T from impacting the stop 10.

The stop 10 is preferably configured so that the tip 60 is truncated along a horizontal line. However, the stop 10 is preferably attached to the bar B (FIGS. 1 and 2) so that it is angled forward from vertical somewhat. In the embodiment depicted, an angle α of 70° is provided between a central axis of the stop 10 and a centerline L of the bar B. This angle α could be between 90° and 45° and still have some effectiveness. An uppermost end of the base end 20 is also preferably cut horizontally so that the overall stop 10 has the form of a parallelogram with opposite corners measuring either 70° or 110°. Other angular measurements could alternatively be provided. In one embodiment, the tip 60 tapers in width between the flanges 12 or other forward and rearward surfaces as it extends down to a lowermost portion thereof.

The stop 10 is positioned strategically so that a tip space S and a main space M are defined (FIG. 1). The tip space S is a portion of the lower edge of the bar B between the stop 10 and the free end E of the bar B. The main space M is a distance between the stop 10 and the root R of the bar B adjacent to the dogs D (if any) on the housing of the chainsaw C. The tip space S is preferably less than half of a size of the main space M. In many embodiments, the tip space S is less than a third of a size of the main space M. Most preferably, if the bar B is of a greater and greater length, the tip space S is held relatively constant at approximately 4 to 5 inches, while the main space S can be allowed to increase to a greater and greater size. Longer bars B can allow for larger and larger material to be cut. Typically material having a diameter of more than 4 inches is not prone to much movement when encountering forces from the chainsaw C acting thereon. Thus, it is generally most preferable to keep the tip space less than 4 or 5 inches to maintain the ability of chainsaws C of all sizes to cut smaller diameter material which is prone to bending and movement during cutting procedures.

The length of the stop 10 defines a height Y between the tip 60 of the stop 10 and the lower edge of the bar B. Most preferably, this height Y is similar to the tip space S, such as about 4 to 5 inches. As an alternative, the tip space S and/or the height Y could be a lesser amount, such as 3 inches or even as little as 2 inches and still maintain at least some limited effectiveness. Generally, the height Y is between half and double the tip space S.

In use and operation, and with particular reference to FIG. 1, details of the use of the chainsaw C with associated stop 10 is described, according to this illustrated embodiment. First, a bar B is selected which has holes H therein, or holes are formed therein as shown (FIG. 2). The stop 10 can then be mounted to the bar B, as illustrated in FIG. 2. As an alternative, a bar B with the stop 10 already attached thereto can be used to replace an existing bar B of a chainsaw C. The chainsaw C will then be configured as shown in FIG. 1.

A user who wishes to rapidly cut both small and large branches starts the chainsaw C and approaches the area to be cut. Using judgment as to which material is best cut first, the user selects a branch, limb or trunk to be cut. If the material W to be cut is smaller than about 4 inches in diameter, the user manipulates at least one grip G on the housing F and orients the chainsaw C relative to the material W to be cut so the material W is engaged by the lower edge of the blade B and the teeth T of the chain forward of the stop 10. Such material W is pinched between a leading portion of the stop 10 and the chain I. The chain I then cuts through the material while the material is supported by the stop 10. The housing F supports a motor of the chainsaw C that is configured to drive the chain I over the bar B.

If the material W to be cut is larger than about 4 inches, the chainsaw C is oriented so that the material W to be cut engages the chain teeth T between the stop 10 and the housing of the chainsaw C. Typically, the dogs D will be allowed to engage the material W being cut, so that additional leverage can be exerted by the user and the larger material W is allowed to be cut by the chain teeth T. This process is then repeated for new material to be cut. The user can move rapidly through large quantities of material W of a wide variety of sizes, which can be useful when cutting paths rapidly through dense brush, such as when cutting firebreak when fighting wildfire or taking preventative measures in advance of wildfire.

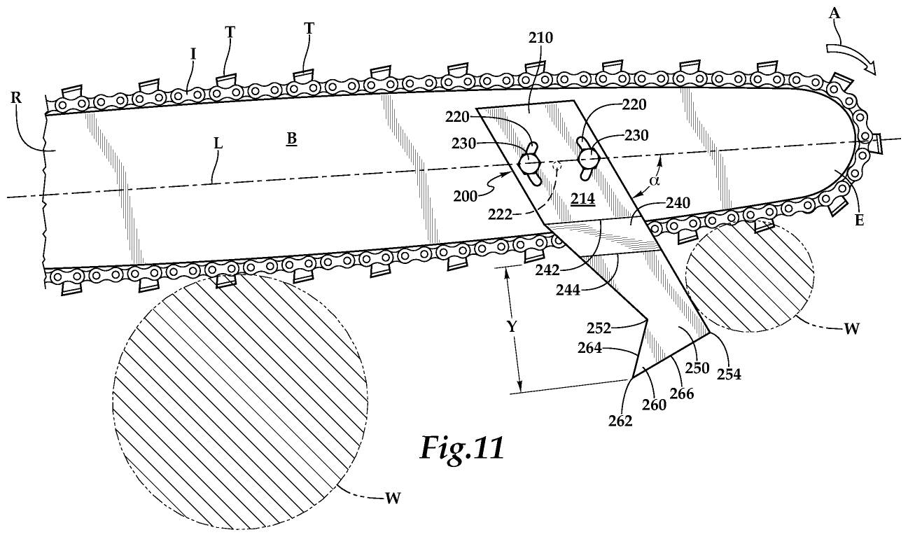

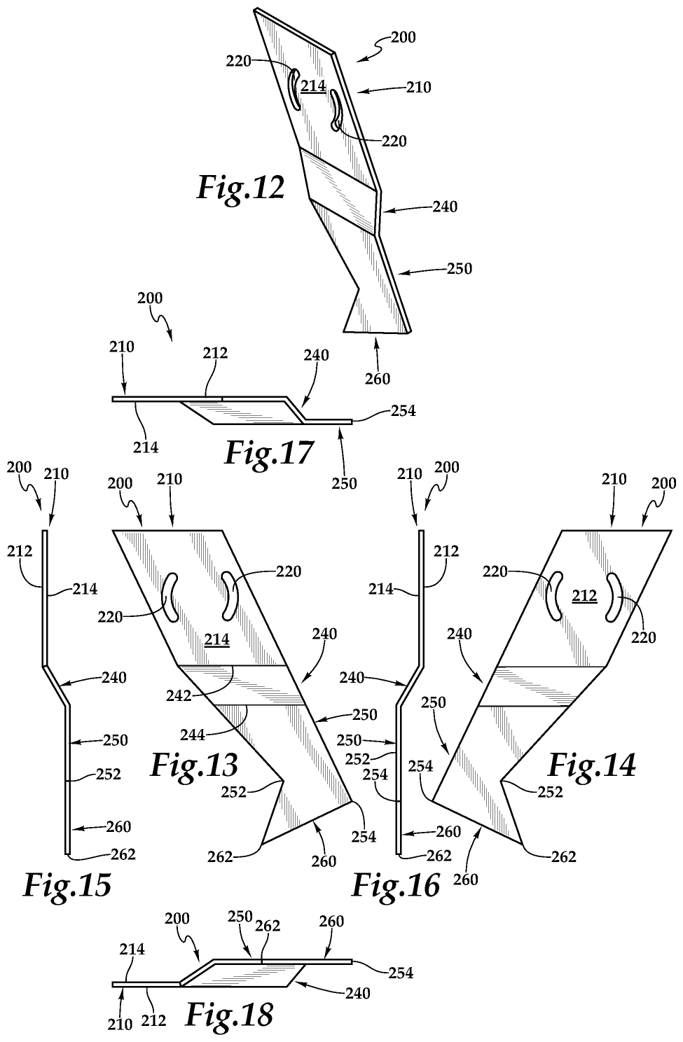

With particular reference to FIGS. 11-18, details of an alternative stop 200 are described. This alternative stop 200 features a hook 260 on a distal end 250 thereof. The hook 260 can be used to engage with pieces of wood and other material for moving of such material. For instance, if some object is in the way of the chainsaw and prevents the chainsaw from being oriented to make a desired cut into a piece of wood W, the hook 260 can be used to engage the object and move it out of the way. If an object of wood W is desired to be cut but it is not positioned optimally, the hook 260 can be used to adjust this piece of wood W so that it has an optimal position and orientation, and then it can be cut with the teeth T on the chain I of the chainsaw. Beneficially, the hook 260 can be so utilized while both hands of the user of the chainsaw remain firmly on handles/grips of the chainsaw for maximal safety.

In this embodiment, the alternate stop 200 includes a base end 210 opposite the distal end 250. The base end 210 is configured to be attached to the bar B of the chainsaw. In this embodiment, the stop 200 is entirely formed from a thin plate of rigid material such as metal, which has been bent to have a configuration such as that shown as an example in FIGS. 11-18. The base end 210 is defined by material located between an inner face 212 and an outer face 214 parallel with the inner face 212 and spaced from the inner face 212 by a thickness of the base end 210.

The base end 210 is aligned within a mounting plane which is parallel with the bar B. The inner face 212 can be placed directly adjacent to the bar B. The base end 210 includes some form of holes passing therethrough which can receive fasteners for securing the base end 210 of the stop 200 to the bar B. These holes could be similar to holes shown in the embodiment of FIGS. 1-10. However, in this embodiment alternative holes are provided in the form of slots 220.

At a minimum, at least one of the holes is in the form of an arcuate slot 220, in this example embodiment. In the embodiment shown, two holes are provided, with each of the holes in the form of an arcuate slot 220. These two arcuate slots 220 extend along portions of a common circle, preferably with these two slots 220 diametrically opposed to each other along this center circle. An optional center hole 222 can also be provided passing through the base end 210, and at a midpoint between the two slots 220.

Fasteners such as bolts pass through the holes/slots 220 (and optionally also through the optional center hole 222) for securing of the base end 210 of the alternate stop 200 to the bar B. For instance, holes in the bar B can be threaded with corresponding threads to threads on bolts 230, so that the bolts 230 can pass through slots 220 or the center hole 222 and then be threaded into these threaded holes in the bar B. As an alternative, such bolts 230 could pass through the holes in the bar B and nuts could be threaded onto the bolts on a side of the bar B opposite the base end 210 of the stop 200.

An angle α defines an orientation of a long axis of the alternate stop 200 relative to a centerline L of the bar B. This angle α can be adjusted by rotation of the stop 200 about a center point between the two arcuate slots 220 while the bolts 230 are loose. The bolts 230 can then be tightened to secure the stop 200 at a desired angle. In one embodiment, this angle is approximately 60° when the bolts reside at midpoints of the arcuate slots 220. The angle α can be adjusted, such as between 30° and 90°, by rotation of the stop 200 about a center point between the two arcuate slots 220.

To provide clearance for the teeth T of the chain I to move past the stop 200 (along arrow A FIG. 11) the stop 200 preferably includes a clearance portion in the form of a transition 240 which is located between the base end 210 and the distal end 250. This transition 240 is preferably planar and located between a first bend 242 adjacent to the base end 210 and a second bend 244 adjacent to the distal end 250. Preferably these bends 242, 244 have a similar angular measure so that the distal end 250 is parallel with the base end 210 but in a free plane parallel with but spaced from the mounting plane in which the base end 210 is oriented.

As an alternative, these bends 242, 244 could have differing angular measures, such as to cause the distal end 250 and its associated free plane to be non-parallel with the mounting plane of the base end 210. For instance, such different angles could allow a tip 262 of the hook 260 to be near or even within the mounting plane, while still providing clearance for the teeth T of the chain I to pass without impacting the stop 200 at the transition 240. Preferably the transition 240 is merely provided by forming the bends 242, 244 in an original piece of elongate rigid material, such as steel, which can be bent through application of appropriate bending tools, such as presses, to form the alternate stop 200 as shown.

The distal end 250 supports the hook 260 at a portion thereof opposite the base end 210. The distal end 250 preferably includes a crotch 252 on an edge thereof closest to the housing and root R of the bar B of the chainsaw. A heel 254 is preferably provided opposite the crotch 252 and a side of the stop 200 closest to the free end E of the bar B. The crotch 252 defines a neck down portion of the distal end 250 just above the hook 260. The heel 254 defines an end of a forward edge of the alternate stop 200 most distant from the housing and root R of the bar B of the chainsaw. The heel 254 defines to some extent a size of wood W which can be located within a tip space beneath the bar B and forward of the alternate stop 200 to be pinched therein for effective cutting thereof. In various alternative environments, this heel 254 can extend further away from the base end 210 then is shown for the heel 254 of FIGS. 11-18.

The hook 260 is defined by an upper edge 264 extending down from the crotch 252 and a lower edge 266 extending down from the heel 254. These edges 264, 266 come together at a tip 262. Preferably the edges 264, 266 are linear and angled apart by an angle of approximately 45°, giving the hook 260 a triangular form. In alternative embodiments, the tip 262 of the hook 260 could be more pointed or less pointed than this example. Furthermore, the hook 260 could be more gradually curved rather than faceted, with curving along at least portions of edges between the crotch 252 and the tip 262 (or even replacing the pointed crotch 252 with a gradual curving crotch), and between the heel 254 and the tip 262.

In one example embodiment, a thickness of the material from which the alternate stop 200 is formed is 0.065 inches and an amount of offset between the mounting plane and the free plane is a quarter inch.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A chainsaw with stop, comprising in combination:
an elongate bar extending from a first end to a second free end;
a chain with cutting teeth carried over upper and lower edges of said bar and routed past said free end of said bar;
a motor within a housing, said motor including an output shaft configured to drive said chain over said bar, and with said housing having at least one grip for handling the chainsaw;
a stop fixed to said bar through a base of said stop;
said stop extending below said lower edge of said bar to a tip, said tip opposite said base;
said stop including a transition which offsets a distal portion of said stop including said tip from said base of said stop, said transition located adjacent to said chain and providing clearance for said chain to pass by said stop without contacting said stop; and
said stop including a hook extending toward said housing from said distal portion of said stop, with said tip on said stop closer to said housing than portions of said stop above said tip.

2. The chainsaw of claim 1 wherein said stop is spaced from said free end of said bar by a tip space, and said stop is spaced from said housing by a main space greater than said tip space, said main space fully open to allow wooden members of a size similar to said main space to access said chain between said stop and said housing.

3. The chainsaw of claim 1 wherein said tip of said stop extends below said lower edge of said bar by a distance between half and two times a distance of said stop from said free end of said bar.

4. The chainsaw of claim 1 wherein said base is planar in form and said distal portion is planar in form, with said base oriented in a first plane and said distal portion is oriented within a second plane.

5. The chainsaw of claim 4 wherein said first plane and said second plane are parallel and spaced from each other.

6. The chainsaw of claim 1 wherein said bar includes a plurality of holes passing therethrough, and wherein said stop includes holes therein which are closer to said base than to said tip, and wherein fasteners secure said stop to said bar by passing of said fasteners through said holes in said stop and said holes in said bar.

7. The chainsaw of claim 6 wherein at least one of said holes and said stop is arcuate in form, such that an angle of said stop relative to said bar can be adjusted.

8. The chainsaw of claim 7 wherein a pair of arcuate holes are provided in said base of said stop, said pair of arcuate holes curving along portions of a common circle.

9. The chainsaw of claim 8 wherein a third hole is provided in said base of said stop, said third hole located between said pair of arcuate holes and at a center of said common circle.

10. A stop attachable to a chainsaw bar, the stop comprising combination:
an elongate rigid structure with a distal portion opposite a base;
at least two holes passing through said base of said stop, said holes each closer to said base than to said tip;
a clearance portion of said rigid structure between said base and said distal portion, said clearance portion spacing a mounting plane from a free plane, said mounting plane where said base of said stop is configured to abut a chainsaw bar surface, and said free plane defining where said distal portion is oriented, such that clearance for chain passage along a lower edge of the bar is provided by said clearance portion, when said base is attached to said bar; and
said distal portion including a hook thereon.

11. The stop of claim 10 wherein said hook extends to a tip with said tip located opposite a heel, with both said tip and said heel located on said distal portion.

12. The stop of claim 11 wherein a crotch is located between said hook and said clearance portion, said crotch defining a portion of said hook opposite said tip.

13. The stop of claim 12 wherein said hook is triangular in form between an upper edge and a lower edge.

14. The stop of claim 13 wherein said hook is of a thin planar form, oriented within said free plane.

15. The stop of claim 10 wherein said clearance portion is a transition between said mounting plane and said free plane, with said transition comprised of at least one bend in said elongate rigid structure between said base and said distal portion.

16. The stop of claim 16 wherein said transition has a planar form between a first bend adjacent to said base and a second bend adjacent to said distal portion, said transition non-parallel with said mounting plane and said free plane.

17. A method for modifying a chainsaw to facilitate cutting of small branches while preserving function of the chainsaw and cutting larger wooden material, the method including the steps of:
attaching a stop to the bar of the chainsaw at a location on the bar closer to a free end of the bar than to a root of the bar where the bar is mounted to a housing, the stop having an elongate rigid structure with a distal portion opposite a base, at least two holes passing through the base of the stop, the holes each closer to the base than to the tip, a clearance portion of the rigid structure between the base and the distal portion, the clearance portion spacing a mounting plane from a free plane, said mounting plane where said base of said stop is configured to abut a chainsaw bar surface, and said free plane defining where said distal portion is oriented, such that clearance for chain passage along a lower edge of the bar is provided by said clearance portion, when said base is attached to said bar, and said distal portion including a hook thereon;
using the chainsaw to cut branches by orienting the branches between the free end of the bar and the tip of the stop; and
using the chainsaw to cut large wooden members by orienting the large wooden members between the stop and the housing of the chainsaw.

18. The method of claim 17 including the further step of using the hook of the stop to engage and move material.

19. The method of claim 18 wherein said attaching step includes the steps of forming holes in the bar; and
passing fasteners between holes in the stop and holes in the bar to secure the stop to the bar.

20. The method of claim 18 wherein said attaching step includes the stop having at least two arcuate slots passing through the base thereof, said arcuate slots extending along portions of a common circle, and with fasteners passing through each of the slots and attaching to portions of the bar.
